(19) United States
(12) Patent Application Publication
(10) Pub. No.: US 2005/0225547 A1
(43) Pub. Date: Oct. 13, 2005

(54) Display system and control method thereof

(75) Inventor: Young-hun Choi, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/102,759

(22) Filed: Apr. 11, 2005

(30) Foreign Application Priority Data
Apr. 9, 2004 (KR) 2004-24567

(51) Int. Cl. G09G 5/08

(52) U.S. Cl. 345/211

(57) ABSTRACT

A display system includes a host that provides digital data, and a display that processes and displays the digital data, wherein the host and display are connected by connectors. The connectors generate a sensing signal that differs according to whether the host and the display are connected or disconnected. A host controller determines whether the display is authenticated by high-bandwidth digital content protection (HDCP), interrupts a digital data transmission when an HDCP authentication error occurs, and restarts the digital data transmission upon determining that the display changes to a connection state from a disconnection state based on the sensing signal. A display controller outputs the sensing signal to allow the host controller to determine a state of the display is as if the display is changed to a connection state from a disconnection state, when the display is in an error state causing the HDCP authentication error.

### CROSS-REFERENCE TO RELATED APPLICATIONS

This application claims the benefit of Korean Patent Application No. 2004-0024567, filed Apr. 9, 2004, in the Korean Intellectual Property Office, the disclosure of which is incorporated herein by reference.

### BACKGROUND OF THE INVENTION

1. Field of the Invention

The present invention relates to a display system and a control method thereof, and more particularly, to a display system and a control method thereof, which automatically prevents data transmission from a host apparatus to a display apparatus from being interrupted when a display apparatus has probability of a high-bandwidth digital content protection (HDCP) authentication error due to a communication error, power resetting, etc.

2. Description of the Related Art

Recently, a digital visual interface (DVI), a high definition multimedia interface (HDMI), or the like have been used to make digital data communication possible between a host apparatus and a display apparatus.

Further, HDCP has been used to protect copyrighted digital data received and transmitted through such an interface from duplication.

According to the HDCP, a host apparatus transmits a predetermined key value to a display apparatus, and the display apparatus receives the key value and transmits a return value corresponding to the key value to the host apparatus. Then, the host apparatus determines whether the return value transmitted from the display apparatus is equal to a predetermined value. When the return value is equal to the predetermined value, the host apparatus permits data to be transmitted to the display apparatus. Conversely, when the return value is not equal to the predetermined value, the host apparatus interrupts the data transmission to the display apparatus.

That is, when the return value is equal to the predetermined value, the host apparatus determines that the display apparatus is authenticated by the HDCP. Conversely, when the return value is not equal to the predetermined value, the host apparatus determines that the display apparatus is not authenticated by the HDCP.

However, even though the display apparatus is already authenticated by the HDCP, the display apparatus may transmit a wrong return value due to a communication error, etc. to the host apparatus. Further, when power of the display apparatus is reset, the return value may not be transmitted to the host apparatus. At this time, the host apparatus determines that the display apparatus is not authenticated by the HDCP, and interrupts the data transmission to the display apparatus.

In this case, if a connector of the display apparatus connected to the host apparatus is unplugged and replugged, the host apparatus determines that the connector of the display apparatus is unplugged and replugged, and restarts communication with the display apparatus. Then, the host apparatus rechecks the HDCP authentication of the display apparatus and permits data to be transmitted to the display apparatus.

### SUMMARY OF THE INVENTION

Accordingly, it is an exemplary aspect of the present invention to provide a display system and a control method thereof, which transmits a signal having the same effect as a connector of a display apparatus being unplugged and replugged, to a host apparatus and automatically prevents data transmission from the host apparatus to the display apparatus from being interrupted when the display apparatus has probability of a HDCP authentication error due to a communication error, power resetting, etc.

The foregoing and/or other exemplary aspects of the present invention are also achieved by providing a display system comprising a host apparatus providing digital data, and a display apparatus processing and displaying the digital data transmitted from the host apparatus, the display system comprising connectors respectively provided in the host apparatus and the display apparatus to connect the host apparatus and the display apparatus, and generate different sensing signals according to whether the host apparatus and the display apparatus are connected or disconnected; a host controller provided in the host apparatus determines whether the display apparatus is authenticated by the HDCP, interrupts the digital data transmission when a HDCP authentication error occurs, and restarts the digital data transmission when the display apparatus is changed to a connection state from a disconnection state as determined on the basis of the sensing signal generated from the connector; and a display controller provided in the display apparatus outputs the sensing signal, which allows the host controller to determine if the display apparatus is changed to a connection state from a disconnection state, through the connector of the display apparatus when the display apparatus is in an error state causing the HDCP authentication error.

According to an illustrative embodiment of the present invention, the sensing signal includes a HPD signal.

According to an illustrative embodiment of the present invention, the error state causing the HDCP authentication error includes at least one of a communication error state and a power resetting state of the display apparatus.

According to an illustrative embodiment of the present invention, the connector of the host apparatus includes one of a HDMI and a DVI.

According to an illustrative embodiment of the present invention, the connector of the display apparatus includes one of a HDMI and a DVI.

According to another illustrative embodiment of the present invention, a method of controlling a display system comprising a host apparatus providing digital data, and a display apparatus processing and displaying the digital data transmitted from the host apparatus is provided, the method comprising determining whether the display apparatus is in an error state causing a HDCP authentication error; transmitting a sensing signal, which allows the host apparatus to determine as if the display apparatus is changed to a connection state from a disconnection state, from the display apparatus to the host apparatus when the display apparatus is in an error state causing the HDCP authentication error; and restarting data transmission when the host apparatus determines that the display apparatus is changed to a connection state from a disconnection state on the basis of the sensing signal.

### BRIEF DESCRIPTION OF THE DRAWINGS

The above and/or other exemplary aspects and advantages of the present invention will become apparent and more readily appreciated from the following description of various illustrative, non-limiting embodiments, taken in conjunction with the accompany drawings of which:

FIG. 1 is a control block diagram of a display system according to an illustrative embodiment of the present invention;

FIG. 2 is a schematic circuit view of a first display apparatus according to an illustrative embodiment of the present invention;

FIG. 3 is a schematic circuit view of a second display apparatus according to an illustrative embodiment of the present invention; and

FIG. 4 is a control flowchart of the display system according to an illustrative embodiment of the present invention.

### DETAILED DESCRIPTION OF ILLUSTRATIVE EMBODIMENTS

Reference will now be made in detail to various illustrative, non-limiting embodiments of the present invention, examples of which are illustrated in the accompanying drawings, wherein like reference numerals refer to like elements throughout. The illustrative embodiments are described below in order to explain the present invention by referring to the figures.

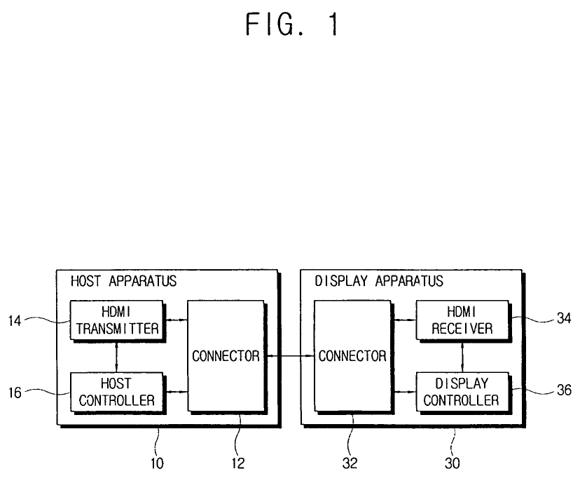

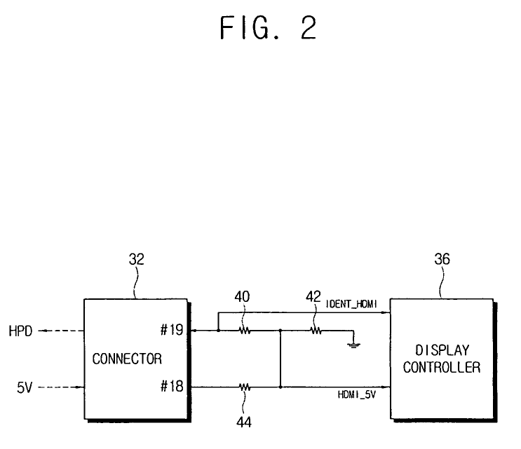

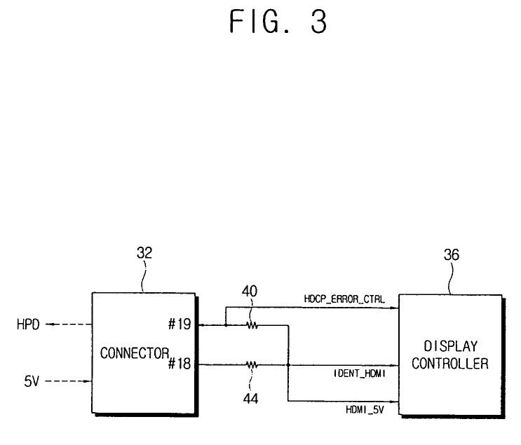

FIG. 1 is a control block diagram of a display system according to an illustrative embodiment of the present invention, and FIGS. 2 and 3 are schematic circuit views of a first and second display apparatus, respectively, according to illustrative embodiments of the present invention.

As shown in FIG. 1, a display system according to an embodiment of the present invention comprises a host apparatus 10 such as a set top box (STB); a digital versatile disk (DVD) player, a computer, etc. which provides digital data; and a display apparatus 30 such as a monitor, a TV, etc., which displays a picture based on the digital data received from the host apparatus 10. Here, the host apparatus 10 and the display apparatus 30 are connected through a HDMI, thereby making digital data communication possible therebetween. Alternatively, a DVI may be used for the data communication.

The host apparatus 10 comprises a connector 12 to be connected with the display apparatus 30, a HDMI transmitter 14 to process the digital data generated from a digital data source (not shown) and to transmit the digital data to the display apparatus 30 through the connector 12, and a host controller 16 to generally control the host apparatus 10.

The display apparatus 30 comprises a connector 32 to be connected with the host apparatus 10, a HDMI receiver 34 to process the digital data received from the host apparatus 10 through the connector 32, and a display controller 36 to generally control the display apparatus 30.

Here, the connectors 12 and 32 of the host apparatus 10 and the display apparatus 30, respectively, comprise the HDMI, but may comprise the DVI.

In the connector 32 of the display apparatus 30 of FIGS. 2 and 3, a signal received and transmitted through predetermined pins is as follows.

As shown in FIGS. 2 and 3, the connector 32 comprises a pin #18 through which a voltage of 5V is applied from the host apparatus 10, and a pin #19 employed as a hot plug detection (HPD) pin for outputting a HPD signal to the host apparatus 10, thereby allowing the host apparatus 10 to detect the display apparatus 30 connected thereto.

When the host apparatus 10 and the display apparatus 30 are connected through the connectors 12 and 32, the host apparatus 10 applies a voltage of 5V to the display apparatus 10 through the pin #18 of the connector 32. Then, a high signal is transmitted to the display controller 36 through a HDMI_{—}5V line and an IDENT_HDMI line connected to the pin #18, so that the display controller 36 determines that the host apparatus 10 is connected to the connector 32.

Further, the voltage of 5V applied from the host apparatus 10 through the pin #18 is returned to the pin #19 via resistors 40 and 44 and employed as the high level HPD signal applied to the host apparatus 10. Thus, the host apparatus 10 determines that the display apparatus 30 is connected to the connector 12 on the basis of the high level HPD signal.

When the connection of the display apparatus 30 is determined on the basis of the high level HPD signal, the host controller 16 reads extended display identification data (EDID) from the display apparatus 30 by display data channel (DDC) communication and stores it, thereby transmitting video data to the display apparatus 30 based on the EDID of the display apparatus 30. Further, the host controller 16 transmits a predetermined key value to the display apparatus 30 so as to determine whether the display apparatus 30 is authenticated by the HDCP. Then, a return value transmitted from the display apparatus 30 is compared with a predetermined value, so that the host controller 16 determines whether the return value transmitted from the display apparatus 30 is equal to the predetermined value. When the return value is equal to the predetermined value, the host controller 16 determines that the display apparatus 30 is authenticated, and permits data to be transmitted to the display apparatus 30. Conversely, when the return value is not equal to the predetermined value, the host controller 16 determines that the display apparatus 30 is not authenticated, and interrupts the data transmission to the display apparatus 30.

Further, in a case where there is a transition from a low level to a high level in the HPD signal received through the connector 12 even though the data transmission to the display apparatus 30 is interrupted, the host controller 16 determines that the display apparatus 30 is changed to a connection state from a disconnection state to the connector 12, and restarts data communication with the display apparatus 30. Here, the restart of the data communication means starting from allowing the host apparatus 10 to store the EDID of the display apparatus 30 through the DDC communication.

Meanwhile, although the display apparatus 30 is already authenticated by the HDCP, there may occur a HDCP authentication error due to a communication error, power resetting, etc. At this time, the display controller 36 outputs a low level signal to the host apparatus 10 through the pin #19 of the connector 32 for a moment and then changes it into a high level signal. Thus, the host controller 16 is prevented from wrongly determining the display apparatus 30 as an unauthenticated display apparatus and interrupting the data transmission.

For reference, FIG. 2 illustrates that the display controller 36 comprises a port through which the IDENT_HDMI signal is inputted and the HPD signal is outputted to the pin #19. FIG. 3 illustrates that the display controller 36 separately comprises a port through which the IDENT_HDMI signal is inputted and a port through which a signal due to the HDCP authentication error is outputted.

In FIG. 2, the resistor 42 is employed for preventing current leakage from flowing in the HDMI_{—}5V line when the host apparatus 10 is disconnected from the connector 32. If the current leakage flows in the HDMI_{—}5V line, the low level signal is not correctly transmitted to the display controller 36, thereby allowing the display controller 36 to wrongly determine that the host apparatus 10 is connected thereto.

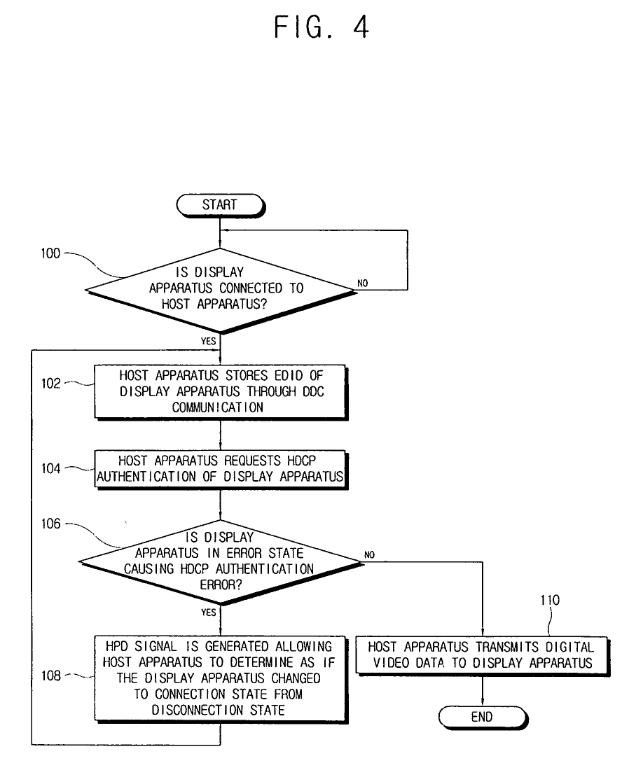

With this configuration, operation of the display system according to an illustrative embodiment of the present invention will be described with reference to FIG. 4. Hereinbelow, suppose that the display apparatus 30 is authenticated by the HDCP.

At operation 100, when the host controller 16 determines that the display apparatus 30 is connected to the host apparatus 10 on the basis of the high level HPD signal, at operation 102 the host controller 16 stores the EDID of the display apparatus 30 through the DDC communication. At operation 104, the host controller 16 transmits a HDCP authentication request signal to the display apparatus 30. At operation 106, the display controller 36 receives the HDCP authentication request signal from the host controller 16 and determines whether the display apparatus 30 has a probability of a HDCP authentication error. When the display apparatus 30 has the probability of the HDCP authentication error, at operation 108 the display controller 36 outputs the HPD signal through the connector 32, therein the HPD signal causing the host controller 16 to determine if the display apparatus 30 is disconnected from and connected to the connector 12. Then, returning to the operation 102, the host apparatus 10 restarts the data communication. Conversely, when the display apparatus 30 does not have the probability of the HDCP authentication error, at operation 110 the display controller 36 normally transmits the return value to the host apparatus 10, thereby allowing the host apparatus 10 to transmit the digital video data to the display apparatus 30.

In the foregoing illustrative embodiment, the host apparatus 10 and the display apparatus 30 are interfaced through the HDMI. However, the host apparatus 10 and the display apparatus 30 may be interfaced through the DVI.

In the foregoing illustrative embodiment, the host apparatus 10 determines that the display apparatus 30 is connected thereto when a high signal is transmitted through the HPD pin. However, the host apparatus 10 may determine that the display apparatus 30 is connected thereto when a low signal is transmitted through the HPD pin.

In the foregoing illustrative embodiment, the display apparatus 30 determines that the host apparatus 10 is connected thereto when the HDMI_{—}5V signal and the IDENT_HDMI signal are high signals. However, the display apparatus 30 may determine that the host apparatus 10 is connected thereto when the HDMI_{—}5V signal and the IDENT_HDMI signal are low signals.

In the foregoing illustrative embodiment, although the display apparatus 30 is already authenticated by the HDCP, the factor causing the HDCP authentication error includes but not limited to a communication error, a power resetting, etc.

Thus, the display apparatus outputs a signal allowing the host apparatus to determine if the display apparatus is disconnected from and reconnected to the host apparatus, through the connector, and automatically prevents data transmission from the host apparatus to the display apparatus from being interrupted when the display apparatus has a probability of the HDCP authentication error due to the communication error, the power resetting, etc.

As described above, the present invention provides a display system and a control method thereof, which automatically prevents data transmission from a host apparatus to a display apparatus from being interrupted when the display apparatus has a probability of a HDCP authentication error due to a communication error, power resetting, etc.

Although various illustrative embodiments of the present invention have been shown and described, it will be appreciated by those skilled in the art that changes may be made in these illustrative embodiments without departing from the principles and spirit of the invention, the scope of which is defined in the appended claims and their equivalents.

1. A display system comprising a host apparatus providing digital data, and a display apparatus processing and displaying the digital data transmitted from the host apparatus, the display system comprising:
a first connector provided in the host apparatus and a second connector provided in the display apparatus, the first connector and the second connector used to connect the host apparatus and the display apparatus, at least one of the first connector and the second connector generating a sensing signal differently according to whether the host apparatus and the display apparatus are connected or disconnected;
a host controller provided in the host apparatus, the host controller determining whether the display apparatus is authenticated by a high-bandwidth digital content protection (HDCP), interrupting the digital data transmission when a HDCP authentication error occurs, and restarting the digital data transmission when determining that the display apparatus is changed to a connection state from a disconnection state on the basis of the sensing signal; and
a display controller provided in the display apparatus, the display controller outputting the sensing signal, which causes the host controller to determine a state of the display apparatus is as if the display apparatus changed to a connection state from a disconnection state, through the second connector when the display apparatus is in an error state causing the HDCP authentication error.

2. The display system according to claim 1, wherein the sensing signal includes a hot plug detection (HPD) signal.

3. The display system according to claim 1, wherein the error state causing the high-bandwidth digital content protection (HDCP) authentication error includes at least one of a communication error state and a power resetting state of the display apparatus.

4. The display system according to claim 2, wherein the error state causing the high-bandwidth digital content protection (HDCP) authentication error includes at least one of a communication error state and a power resetting state of the display apparatus.

5. The display system according to claim 1, wherein the first connector includes one of a high definition multimedia interface (HDMI) and a digital visual interface (DVI).

6. The display system according to claim 1, wherein the second connector includes one of a high definition multimedia interface (HDMI) and a digital visual interface (DVI).

7. The display system according to claim 2, wherein the first connector includes one of a high definition multimedia interface (HDMI) and a digital visual interface (DVI).

8. The display system according to claim 2, wherein the second connector includes one of a high definition multimedia interface (HDMI) and a digital visual interface (DVI).

9. A method of controlling a display system comprising a host apparatus providing digital data, and a display apparatus processing and displaying the digital data transmitted from the host apparatus, the method comprising:
determining whether the display apparatus is in an error state causing a high-bandwidth digital content protection (HDCP) authentication error;
transmitting a sensing signal, which causes the host apparatus to determine a state of the display apparatus is as if the display apparatus changed to a connection state from a disconnection state, from the display apparatus to the host apparatus when the display apparatus is in an error state causing the HDCP authentication error; and
restarting a data transmission from the host apparatus to the display apparatus when the host apparatus determines that the display apparatus is changed to a connection state from a disconnection state on the basis of the sensing signal.

10. The display system according to claim 9, wherein the sensing signal includes a hot plug detection (HPD) signal.

11. The display system according to claim 9, wherein the error state causing the high-bandwidth digital content protection (HDCP) authentication error includes at least one of a communication error state and a power resetting state of the display apparatus.

12. The display system according to claim 10, wherein the error state causing the high-bandwidth digital content protection (HDCP) authentication error includes at least one of a communication error state and a power resetting state of the display apparatus.

13. A display system comprising a host apparatus providing digital data, and a display apparatus processing and displaying the digital data transmitted from the host apparatus, the display system comprising:
determining means for determining whether the display apparatus is in an error state causing a high-bandwidth digital content protection (HDCP) authentication error;
signaling means for transmitting a sensing signal from the display apparatus to the host apparatus when the display apparatus is in an error state causing the HDCP authentication error, the sensing signal causing the host apparatus to determine a state of the display apparatus is as if the display apparatus changed to a connection state from a disconnection state; and
restarting means for restarting a data transmission from the host apparatus to the display apparatus when the host apparatus determines that the display apparatus is changed to a connection state from a disconnection state on the basis of the sensing signal.
